(19) United States
(12) Patent Application Publication
(10) Pub. No.: US 2014/0245837 A1
(43) Pub. Date: Sep. 4, 2014

(54) Pressure Sensor

(71) Applicant: TRANSDUCERS DIRECT LLC, Cincinnati, OH (US)

(72) Inventors: Robert W. Matthes, Loveland, OH (US); David A. Topmiller, Edgewood, KY (US)

(73) Assignee: Transducers Direct LLC, Cincinnati, OH (US)

(21) Appl. No.: 13/781,830

(22) Filed: Mar. 1, 2013

(51) Int. Cl. G01L 19/00

(52) U.S. Cl. CPC G01L 19/0092
USPC 73/714

(57) ABSTRACT

A pressure sensor is disclosed for measuring the pressure of a fluid, the pressure sensor comprising an atmospheric pressure sensing element, a fluid pressure sensing element, a processing unit, and a switch. The atmospheric pressure sensing element measures atmospheric pressure and the fluid pressure sensing element measures relative pressure of the fluid with respect to the atmospheric pressure. The switch is electrically coupled to the processing unit and comprises a first state and a second state, wherein: when the switch is set to the first state, the processing unit determines the absolute pressure of the fluid, and the processing unit generates an output corresponding to the absolute pressure of the fluid; and when the switch is set to the second state, the processing unit determines the relative pressure of the fluid, and the processing unit generates an output corresponding to the relative of the fluid.

### TECHNICAL FIELD

The present disclosure generally relates to pressure sensors and, in particular, to pressure sensors capable of measuring the absolute or relative pressure of a fluid.

### BACKGROUND

As background, pressure sensors are electronic transducers which measure the pressure of a fluid and convert said measurement into one or more corresponding electrical output signals. The one or more electrical output signals produced by the pressure sensor may comprise, inter alia, an analog voltage (e.g., 0 to 10 Volts), an analog current (e.g., 4 to 20 mA), one or more bus system signals (e.g., Ethernet, CANopen or HART protocol), or a wireless signal (e.g., Wi-Fi, Bluetooth, or cellular). Other types of electrical output signals may be produced as well, as is known in the art.

One type of prior art pressure sensor may only be capable of measuring the absolute pressure of the fluid. The absolute pressure of the fluid is the pressure of the fluid with respect to a perfect vacuum. Another type of prior art pressure sensor may only be capable of measuring the relative pressure of a fluid. The relative pressure of the fluid is the pressure of the fluid with respect to the ambient atmospheric pressure. Generally, the user of the pressure sensor determines what type of measurement is required for a particular application and selects either an absolute pressure sensor or a relative pressure sensor accordingly.

The embodiments of a pressure sensor shown and described herein may be capable of measuring both the absolute pressure and the relative pressure of the fluid. The pressure sensor may have an input which permits a user to select whether the pressure sensor measures the absolute pressure of the fluid or the relative pressure of the fluid. In this fashion, a single pressure sensor may be used in applications which require either an absolute pressure sensor or a relative pressure sensor. This may permit the manufacturer and/or user of the pressure sensor to reduce cost, reduce inventory, and offer flexibility by having the capability to select the type of pressure measurement desired (i.e., absolute or relative).

### SUMMARY

A pressure sensor is disclosed for measuring the pressure of a fluid, the pressure sensor comprising an atmospheric pressure sensing element, a fluid pressure sensing element, a processing unit, a switch, and an interface unit. The atmospheric pressure sensing element is operable to measure atmospheric pressure and is electrically coupled to the processing unit such that the processing unit is operable to read a measured atmospheric pressure from the atmospheric pressure sensing element. The fluid pressure sensing element is mechanically coupled to the fluid and is operable to measure relative pressure of the fluid with respect to the atmospheric pressure, and the fluid pressure sensing element is electrically coupled to the processing unit such that the processing unit is operable to read a measured relative pressure of the fluid from the fluid pressure sensing element. The interface unit is electrically coupled to the processing unit and is operable to receive a digital number from the processing unit and convert the digital number to an output signal. The switch is electrically coupled to the processing unit and comprises a first state and a second state, wherein: when the switch is set to the first state, the processing unit determines the absolute pressure of the fluid based on the measured atmospheric pressure and the measured relative pressure of the fluid, and the digital number and the output signal correspond to the absolute pressure of the fluid; and when the switch is set to the second state, the processing unit determines the relative pressure of the fluid based on the measured relative pressure of the fluid, and the digital number and the output signal correspond to the relative pressure of the fluid.

A method is disclosed for configuring a pressure sensor for measuring the pressure of a fluid. The pressure sensor comprises an atmospheric pressure sensing element, a fluid pressure sensing element, a processing unit, a switch, and an interface unit. The atmospheric pressure sensing element is operable to measure atmospheric pressure and is electrically coupled to the processing unit such that the processing unit is operable to read measured atmospheric pressure from the atmospheric pressure sensing element. The fluid pressure sensing element is mechanically coupled to the fluid and is operable to measure relative pressure of the fluid with respect to the atmospheric pressure, and the fluid pressure sensing element is electrically coupled to the processing unit such that the processing unit is operable to read a measured relative pressure of the fluid from the fluid pressure sensing element. The interface unit is electrically coupled to the processing unit and is operable to receive a digital number from the processing unit and convert the digital number to an output signal. The switch is electrically coupled to the processing unit and comprises a first state and a second state, wherein: when the switch is set to the first state, the processing unit determines the absolute pressure of the fluid based on the measured atmospheric pressure and the measured relative pressure of the fluid, and the digital number and the output signal correspond to the absolute pressure of the fluid; and when the switch is set to the second state, the processing unit determines the relative pressure of the fluid based on the measured relative pressure of the fluid, and the digital number and the output signal correspond to the relative pressure of the fluid. And the method comprises: setting the switch to the first state such that the pressure sensor measures the absolute pressure of the fluid, or setting the switch to the second state such that the pressure sensor measures the relative pressure of the fluid.

### BRIEF DESCRIPTION OF THE DRAWINGS

The embodiments set forth in the drawings are illustrative and exemplary in nature and not intended to limit the inventions defined by the claims. The following detailed description of the illustrative embodiments can be understood when read in conjunction with the following drawings, where like structure is indicated with like reference characters and in which:

FIGS. 1, 2, and 3 depict a block diagram of pressure sensors according to one or more embodiments shown and described herein;

FIGS. 4 and 5 show switches according to one or more embodiments shown and described herein;

FIG. 6 depicts a processing unit according to one or more embodiments shown and described herein;

FIG. 7 illustrates a cut away view of a pressure sensor according to one or more embodiments shown and described herein; and

FIG. 8 shows a schematic of a fluid pressure sensing element according to one or more embodiments shown and described herein.

### DETAILED DESCRIPTION

The embodiments shown and described herein generally relate to pressure sensors which are capable of measuring the absolute pressure of a fluid or the relative pressure of a fluid. In one embodiment, a pressure sensor may comprise a switch which may be capable of being set to a first state or a second state. When the switch is set to the first state, the pressure sensor may determine the absolute pressure of the fluid based on the measured atmospheric pressure and the measured relative pressure of the fluid. Alternatively, when the switch is set to the second state, the pressure sensor may determine the relative pressure of the fluid based on the measured relative pressure of the fluid. Such a pressure sensor may provide a manufacturer or a user of the pressure sensor the capability of quickly and easily converting the pressure sensor from an “absolute pressure sensor” to a “relative pressure sensor” and vice versa.

For the purposes of this disclosure, a “fluid” is defined as any material or substance which is capable of continuously deforming in the presence of an applied force and may include gases, liquids, plasmas, plastic solids, and any combination thereof. Examples of fluids include but are not limited to air, nitrogen, oxygen, carbon dioxide, natural gas, ammonia, hydraulic fluid, water, and molten plastic. Fluids may include both gaseous and liquid materials at the same time and may also comprise one or more different kinds of materials such as, for example, nitrogen and oxygen.

The absolute and relative pressure of the fluid may be measured in pounds per square inch (psi), bar, millibar, Pascals (Pa), kiloPascals (kPa), megaPascals (MPa), or any other suitable unit of measurement. For the purposes of this disclosure, pounds per square inch will primarily be used, and when the measurement is absolute (i.e., with respect to a perfect vacuum), it will be denoted as “psia” (“pounds per square inch, absolute”); when the measurement is relative (i.e., with respect to the ambient atmospheric pressure), it will be denoted as “psig” (“pound per square inch, gauge”). For the purposes of this disclosure, the atmospheric pressure is measured with respect to a perfect vacuum and will be denoted as “psia.” It is to be understood that atmospheric pressure may also be measured in other units, including millimeters of mercury (mmHg) and inches of mercury (inHg). The atmospheric pressure on earth typically can vary from about 13.25 psia to about 15.75 psia and can be affected by altitude, temperature, weather, and other factors.

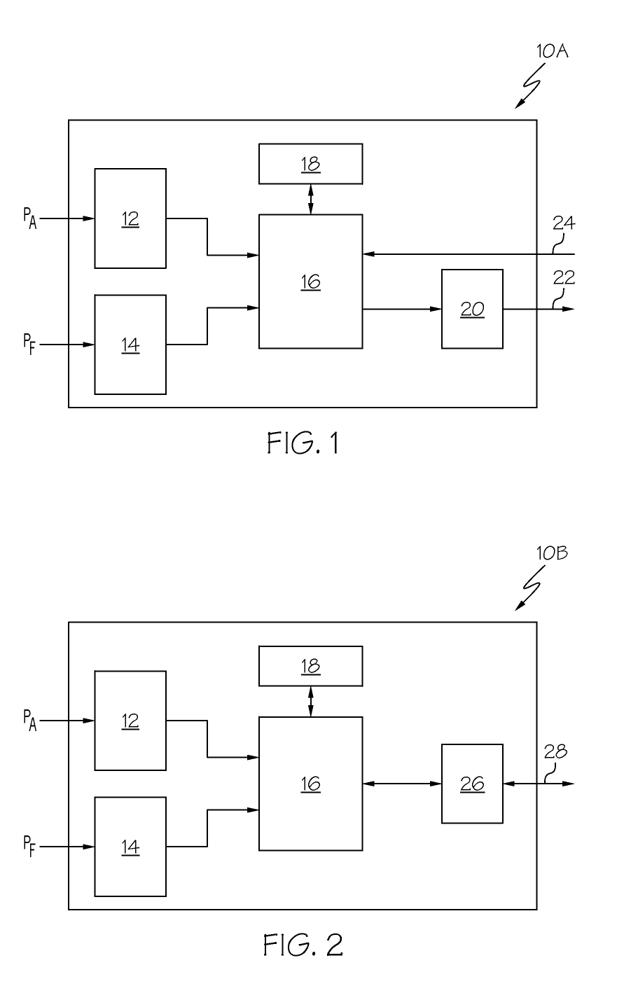

FIG. 1 depicts a block diagram of pressure sensor 10A according to one embodiment shown and described herein. The pressure sensor 10A may comprise an atmospheric pressure sensing element 12, a fluid pressure sensing element 14, a processing unit 16, a switch 18, and an interface unit 20. The interface unit 20 may be operable to receive a digital number from the processing unit 16 which corresponds to the absolute pressure of the fluid or the relative pressure of the fluid. The interface unit 20 may be operable to convert the digital number from the processing unit 16 into an output signal 22 corresponding to the absolute pressure of the fluid or the relative pressure of the fluid. The processing unit 16 may also be operable to receive an input signal 24 such as, for example, an asynchronous serial input comprising one or more message bytes.

The atmospheric pressure sensing element 12 may be operable to measure atmospheric pressure P_{A} and may be electrically coupled to the processing unit 16 such that the processing unit 16 is operable to read a measured atmospheric pressure from the atmospheric pressure sensing element 12. The atmospheric pressure sensing element 12 may comprise an electronic device that is capable of measuring the atmospheric pressure such as, for example, the LPS331AP device from ST Microelectronics (Geneva, Switzerland; www.st.com). The LPS331AP is a single-chip sensor which uses a monolithic sensing element and an integrated circuit to provide a digital output signal corresponding to the measured atmospheric pressure. The LPS331AP can be configured to operate with either an SPI (serial peripheral interface) or an I²C (inter-integrated circuit) interface. Thus, the processing unit 16 may read the measured atmospheric pressure from the LPS331AP via an SPI or I²C interface. The LPS331AP may also be initialized and/or setup by the processing unit 16 via the same interface. The update rate of the LPS331AP is programmable from 1 Hz to 25 Hz, and the LPS331AP may periodically measure the atmospheric pressure at this rate. The atmospheric pressure is converted by the LPS331AP into a digital output signal representing the measured atmospheric pressure in units of millibar such that the processing unit 16 reads this digital output signal as the measured atmospheric pressure. The LPS331AP may be calibrated at the factory so that it has an absolute accuracy of about ±2.6 millibar. The processing unit 16 may convert the measured atmospheric pressure from millibar to psia or any other suitable unit of measurement.

As another example, the atmospheric pressure sensing element 12 may comprise the MS5607-02BA03 device from Measurement Specialties, Inc. (Hampton, Va.; www.meas-spec.com). The MS5607-02BA03 device is based on MEMS (micro-electromechanical systems) and may also be configured to operate with either an SPI or I²C interface. Still another example of an atmospheric pressure sensing element 12 is the BMP180 or BMP280 from Bosch Sensortec GmbH (Reutlingen, Germany; www.bosch-sensortec.com). Other types of devices may be used as well, as is known in the art. Furthermore, it is contemplated that the atmospheric pressure sensing element 12 may be constructed of discrete components such as transistors, resistors, capacitors, and so forth. The atmospheric pressure sensing element 12 may be physically disposed within the pressure sensor 10A such that the atmospheric pressure sensing element 12 is exposed to the ambient atmospheric pressure P_{A}. Accordingly, a housing (not shown) of the pressure sensor 10A may have a vent hole or other suitable means to permit the atmospheric pressure sensing element 12 to have access to the atmospheric pressure P_{A}.

Continuing to refer to FIG. 1, the fluid pressure sensing element 14 may be mechanically coupled to the fluid and may be operable to measure relative pressure of the fluid P_{F} with respect to the atmospheric pressure. The fluid pressure sensing element 14 may also be electrically coupled to the processing unit 16 such that the processing unit 16 is operable to read a measured relative pressure of the fluid from the fluid pressure sensing element 14. The fluid pressure sensing element 14 may comprise one or more resistive pressure sensing elements (not shown) which are mechanically coupled to the fluid such that the resistance of the resistive pressure sensing elements change when the relative pressure of the fluid P_{F} changes. The fluid pressure sensing element 14 may further comprise an analog-to-digital converter (not shown) which may be operable to measure the resistance of the pressure sensing elements and convert these measurements into a number corresponding to the relative pressure of the fluid. The analog-to-digital converter may be electrically coupled to the processing unit 16 such that the processing unit 16 is operable to read the relative pressure of the fluid from the analog-to-digital converter. The fluid pressure sensing element 14 is discussed in more detail below.

The switch 18 may comprise a mechanical or an electronic device which comprises two states: a first state and a second state. The switch 18 may be capable of being set to either the first state or the second state. If the switch 18 comprises a mechanical switch, a user or a manufacturer of the pressure sensor 10A may set the switch 18 to the first state or the second state by physically adjusting the mechanical switch. Alternatively, if the switch 18 comprises an electronic switch (e.g., a register in memory), the switch 18 may be set to the first state or the second state by the processing unit 16 via an electronic means. In this embodiment, the processing unit 16 may receive a message via the input signal 24 which may command the processing unit 16 to set the state of the switch 18. The message received via the input signal 24 may be transmitted by a user or a manufacturer of the pressure sensor 10A.

The switch 18 may be electrically coupled to the processing unit 16 such that the processing unit 16 is operable to read the state of the switch 18. When the switch 18 is set to the first state, the processing unit 16 may determine the absolute pressure of the fluid based on the measured atmospheric pressure and the measured relative pressure of the fluid, and the processing unit 16 may generate and transmit a digital number to the interface unit 20 which corresponds to the absolute pressure of the fluid. When the switch 18 is set to the second state, the processing unit 16 may determine the relative pressure of the fluid based on the measured relative pressure of the fluid, and the processing unit 16 may generate and transmit a digital number to the interface unit 20 which corresponds to the relative pressure of the fluid. The interface unit 20 may receive the digital number and convert it to an output signal 22 which corresponds to the absolute or relative pressure of the fluid.

The processing unit 16 may determine the absolute pressure of the fluid by adding the measured atmospheric pressure and the measured relative pressure of the fluid. This may be possible since the relative pressure of the fluid may be measured with respect to the atmospheric pressure; and, in order to obtain the absolute pressure of the fluid (i.e., with respect to a perfect vacuum), the processing unit 16 may simply add the measured atmospheric pressure to the measured relative pressure of the fluid. In this case, the units of the measured atmospheric pressure and the measured relative pressure of the fluid should be the same (e.g., psi). For example, the measured relative pressure of the fluid may be in units of psig, and the measured atmospheric pressure may be in units of psia; adding them together may provide an absolute measurement of the fluid in units of psia.

Similarly, the processing unit 16 may determine the relative pressure of the fluid by simply using only the measured relative pressure of the fluid. That is, the measured atmospheric pressure may be ignored for relative pressure measurements of the fluid. In this case, the processing unit 16 may continue to read the measured atmospheric pressure from the atmospheric pressure sensing element 12 (even though the measured atmospheric pressure may not be used to determine the relative pressure of the fluid). Alternatively, the processing unit 16 may stop reading the atmospheric pressure sensing element 12 and/or may disable it to conserve power. The measured relative pressure of the fluid may be in units of psig.

As discussed above, the input signal 24 may comprise an asynchronous serial message comprising one or more message bytes. For example, the input signal 24 may comprise a standard RS-232, RS-422, or RS-485 asynchronous serial interface which may comprise a serial output signal as well (not shown). The input signal 24 (and serial output signal, if used) may operate at 24 Volts, 12 Volts (e.g., RS-232), 5 Volts (e.g., RS-422 or RS-485), or any other suitable voltage level. The serial interface may be either full duplex or half duplex and may operate at 9600 baud with each data byte transmitted comprising one start bit, 8 data bits, no parity, and one stop bit. The asynchronous serial interface may operate with other baud rates and other communication settings as well. The input signal 24 may comprise one or more message bytes which, when combined, may form a command message to the processing unit 16 which may command the processing unit 16 to set the state of the switch 18 to the first state or the second state. The message bytes may comprise, for example, a start byte, a command byte, one or more date bytes, and a checksum byte. The start byte may be 0x01 (the “0x” prefix will hereinafter be used to denote a hexadecimal number), and the command byte may be 0x8b. The data byte may be 0x00 to command the processing unit 16 to set the switch 18 to the first state; while the data byte may be 0x01 to command the processing unit 16 to set the switch 18 to the second state. The checksum may be the modulo-8 sum of the preceding message bytes and may be used to help insure that there were no transmission errors. A cyclic redundancy check (CRC) may be used as an alternative to the checksum. In one embodiment, an external programming device may be used to set up the operation of the pressure sensor 10A by transmitting messages via the input signal 24. In addition to setting the switch 18 to either the first state or the second state, the input signal 24 may allow the pressure sensor 10A to be set up with regard to its operating pressure range, its analog output range, and/or any other suitable parameters which may be capable of being programmed.

As shown in FIG. 1, the input signal 24 may be electrically coupled to the switch 18 via the processing unit 16. That is, the processing unit 16 may receive a message via the input signal 24, and the processing unit 16 may set the state of the switch 18 based on the type of message received via the input signal 24. If no messages are received which change the state of the switch 18, the processing unit 16 may merely read the state of the switch 18 and determine the absolute or relative pressure of the fluid, depending on whether the switch 18 is set to the first state or the second state.

The processing unit 16 may comprise a microprocessor, microcontroller, or other suitable device. In one embodiment, the processing unit 16 may comprise a PIC24F16KA101 microcontroller from Microchip Technology, Inc. (Chandler, Ariz.; www.microchip.com). The PIC24F16KA101 is a 16-bit device which includes program memory, data memory (RAM), non-volatile memory (EEPROM), and numerous peripherals (e.g., timers, UARTs, SPI module, etc.) As discussed above, the processing unit 16 may read the atmospheric pressure sensor 12 and the fluid pressure sensing element 14 via an SPI or I²C interface. Likewise, the processing unit 16 may transmit the digital number corresponding to the absolute or relative pressure of the fluid to the interface unit 20 via the same interface or a different interface.

In one embodiment, the interface unit 20 may comprise a digital-to-analog converter. The digital-to-analog converter may be capable of generating an output signal 22, which may comprise an analog voltage or an analog current which corresponds to the absolute or relative pressure of the fluid. If the digital-to-analog converter generates an analog voltage, the output signal 22 may range from approximately zero volts to approximately 10 Volts. Other voltage ranges may be used as well, as is known in the art. In this embodiment the interface unit 20 may further comprise a voltage reference, and one or more op amps. For example, the digital-to-analog converter may comprise an LTC2601 16-bit D/A chip from Linear Technology, Inc. (Milpitas, Calif.; www.linear.com). The LTC2601 has an SPI interface, and requires a voltage reference, such as an LT1790-2.5, also available from Linear Technology, Inc. In this configuration, the LTC2601 may be capable of generating from approximately zero Volts to approximately 2.5 Volts at a resolution of 16 bits (65536 steps). An op amp, such as a LT1636 from Linear Technology, Inc., may be used to increase the LT2601 output from approximately 2.5 Volts to approximately 10 Volts (i.e., with an amplifier gain of 4).

If the digital-to-analog converter generates an analog current, the output signal 22 may range from approximately 4 mA to approximately 20 mA. Other current ranges may be used as well, as is known in the art. In this embodiment the interface unit 20 may further comprise a voltage reference, and a V/I (voltage-to-current converter) chip. For example, the D/A chip may comprise an LTC2601, and the voltage reference may comprise an LT1790-2.5, as discussed above. The V/I chip may comprise an XTR111 from Texas Instruments, Inc. (Austin, Tex.; www.ti.com). The XTR111 may convert the voltage from the LTC2601 into a corresponding output current (e.g., 4 mA to 20 mA).

Turning now to FIG. 2, another embodiment of a pressure sensor 10B is illustrated which comprises an atmospheric pressure sensing element 12, a fluid pressure sensing element 14, a processing unit 16, switch 18, and a bus interface unit 26. The atmospheric pressure sensing element 12, the fluid pressure sensing element 14, the processing unit 16, and the switch 18 may comprise similar components which have been described above. The bus interface unit 26 may comprise a device operable to electrically connect the pressure sensor 10B to a bus system such as Ethernet, CANopen, HART protocol, or any other suitable bus. In this embodiment, the processing unit 16 may transmit a digital number to the bus interface unit 26 which corresponds to the absolute and/or relative pressure of the fluid. The bus interface unit 26 may receive this digital number and transmit one or more output signals 28 which correspond to the absolute and/or relative pressure of the fluid. For example, if the bus interface unit 26 comprises an Ethernet interface, the pressure sensor 10B may transmit one or more output signals 28 which conform to the Ethernet standard and which correspond to the absolute and/or relative pressure of the fluid (i.e., depending on the state of the switch 18). The one or more output signals 28 may be transmitted to one or more devices which are also electrically connected to the bus.

Furthermore, the bus interface unit 26 may also be capable of receiving commands via the bus. These commands may be capable of instructing the processing unit 16 to set the switch 18 to either the first state or the second state. Thus, the pressure sensor 10B may be capable of being configured via the bus to which it is electrically connected. In addition to the state of the switch 18, other parameters of the pressure sensor 10B may be set up as well via the bus interface. Furthermore, the bus may be capable of reading other data from the pressure sensor 10B (i.e., in addition to the absolute and/or relative pressure of the fluid.) For example, the bus may be able to read the maximum pressure that the pressure sensor 10B has observed or the number of time the pressure of the fluid exceeded a pre-determined threshold.

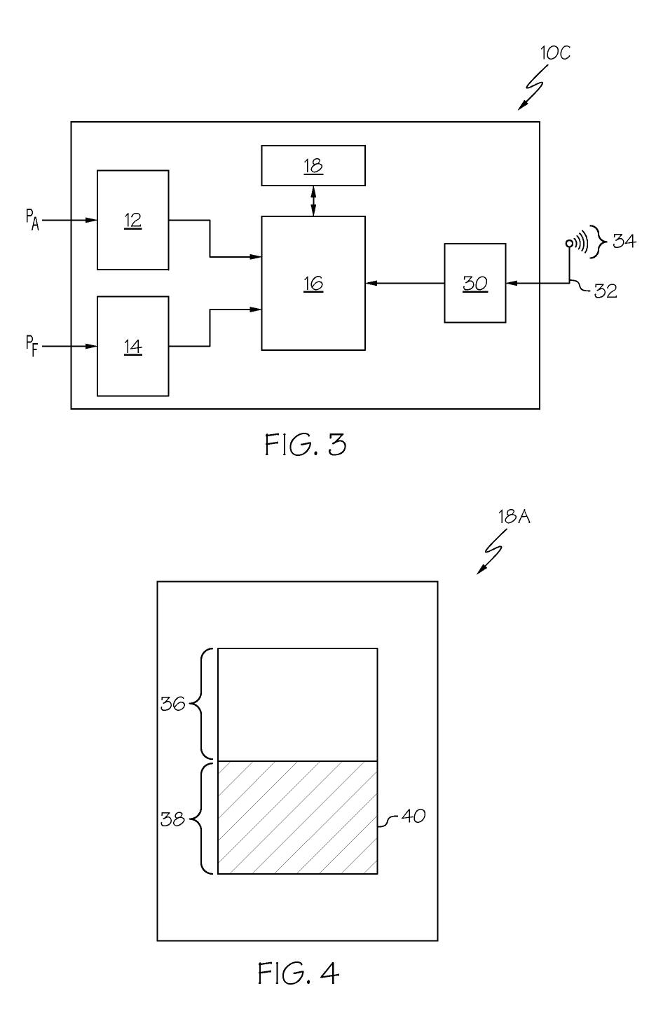

FIG. 3 illustrates yet another pressure sensor 10C according to one or more embodiments shown and described herein. The pressure sensor 10C may comprise an atmospheric pressure sensing element 12, a fluid pressure sensing element 14, a processing unit 16, switch 18, a wireless interface unit 30, and an antenna 32. The atmospheric pressure sensing element 12, the fluid pressure sensing element 14, the processing unit 16, and the switch 18 may comprise similar components which have been described above. The wireless interface unit 30 may comprise a device operable to wirelessly connect the pressure sensor 10C to a wireless system such as Wi-Fi, Bluetooth, cellular, or any other suitable wireless system. In this embodiment, the processing unit 16 may transmit a digital number to the wireless interface unit 30 which corresponds to the absolute and/or relative pressure of the fluid. The wireless interface unit 30 may receive this digital number and wirelessly transmit one or more output signals 34 which correspond to the absolute and/or relative pressure of the fluid. The antenna 32 may be electrically coupled to the wireless interface unit 30 and may facilitate the wireless transmission of output signals 34 or the wireless reception of wireless messages.

The wireless interface unit 30 may comprise a Wi-Fi interface which may conform to the IEEE 802.11 standard promulgated by the Institute of Electrical and Electronic Engineers. The processing unit 16 may be electrically coupled to the Wi-Fi interface such that the processing unit 16 is capable of sending and/or receiving wireless messages (e.g., one or more output signals 34) via the Wi-Fi interface. The wireless interface unit 30 may further comprise an IP (Internet Protocol) address, which may facilitate the transmission of wireless messages via the Wi-Fi interface to and from any other IP-enabled device via TCP/IP protocol. Other communication protocols may be used as well.

In one embodiment, the Wi-Fi interface may be wirelessly coupled to an external device with access to the internet (e.g., a wireless router or wireless access point). This external device may be connected to the internet via a wired or a wireless means. Accordingly, the wireless interface unit 30 may be capable of transmitting one or more output signals 34 to (and also receiving wireless messages from) a computer or a smartphone (e.g., an iPhone®, Android®, or Windows® phone) which also has access to the internet (e.g., via the smartphone's cellular network). The wireless interface unit 30 may send a message to the smartphone, for example, corresponding to the absolute and/or relative pressure of the fluid. In this scenario, the user of the smartphone may be miles away from the pressure sensor 10C and still receive messages from the pressure sensor 10C. The one or more output signals 34 may also comprise a text message which may be transmitted to a smartphone using SMS (Short Message Service), email, or any other suitable text messaging service. In addition, the text message may have embedded graphics and/or video.

As an alternative, the wireless interface unit 30 may comprise a Bluetooth interface which may conform to the Bluetooth 4.0 Specification promulgated by the Bluetooth Special Interest Group (www.bluetooth.org). The Bluetooth interface may be capable of wirelessly sending and/or receiving wireless messages via the antenna 32. The processing unit 16 may be electrically coupled to the wireless interface unit 30 such that the processing unit 16 is operable to send and receive wireless messages (e.g., one or more output signals 34) via the Bluetooth interface.

The Bluetooth interface may permit the pressure sensor 10C to communicate to an external device which also conforms to the same Bluetooth 4.0 Specification. Such an external device may include a smartphone, a tablet computer, or a personal computer. The current Bluetooth specification only permits the wireless messages to be reliably transmitted at relatively short distances, about 150 feet or less; that is, the receiving device should be within about 150 feet of the atmospheric pressure sensor for reliable transmission of the message. Thus, this type of interface may work well when the external device is always relatively nearby the pressure sensor 10C.

The Bluetooth interface may also work well when the pressure sensor 10C is powered by a battery, a solar cell, or other low energy device. The Bluetooth 4.0 Specification permits an operating mode, called Bluetooth Low Energy, which is designed to use very little energy. As such, the pressure sensor 10C may transmit information (i.e., in a Bluetooth LE advertising packet) to the receiving device at a relatively long communication rate of, for example, once per minute. This information may include the measured absolute and/or relative pressure of the fluid, the battery level, and so forth. Such a communication rate may be long enough to conserve battery life while still providing the user of the receiving device relatively up-to-date information about the pressure of the fluid. In one embodiment, the one or more output signals 34 may conform to the Bluetooth Low Energy protocol.

In yet another embodiment, the wireless interface unit 30 may comprise a cellular network interface. The processing unit 16 may be electrically coupled to the cellular network interface such that the processing unit 16 is capable of wirelessly sending and/or receiving wireless messages (e.g., the one or more output signals 34) via the cellular network interface. The cellular network interface may conform to the 3G, 4G, or any other suitable cellular network standard. In one embodiment, the cellular network interface may conform to the 4G cellular network standard.

The one or more output signals 34 may be transmitted to a cellular tower. The one or more output signals 34 transmitted to an external device (not shown) may first be transmitted from the cellular network interface (via the antenna 32) to the cellular tower. They may then be transmitted to the external device via the cellular tower. In another scenario, the one or more output signals 34 may first be transmitted to the cellular tower, then transmitted to a second cellular tower (not shown) which may be proximate to the external device, and finally transmitted from the second cellular tower to the external device. As such, the pressure sensor 10C may transmit wireless messages directly to an external device via one or more cellular towers. The wireless messages may comprise a voice message, a text message (e.g., via SMS messaging service), an email, or any other suitable message.

FIG. 4 illustrates a switch 18A according to one embodiment. The switch 18A may be a mechanical switch, and its state may be set by the user or the manufacture of the pressure sensor. The switch 18A may have a first position 36 and a second position 38. The switch 18A may have a slider 40 which may be moveable to either the first position 36 or the second position 38. As shown in FIG. 4, the slider 40 is in the second position 38. When the slider 40 is set to the first position 36, the processing unit may electrically read the switch 18A as being in the first state. Likewise, when the slider 40 is set to the second position 38, the processing unit may electrically read the switch 18A as being in the second state. In this fashion, the processing unit may read the switch 18A and either determines the absolute pressure of the fluid or the relative pressure of the fluid accordingly.

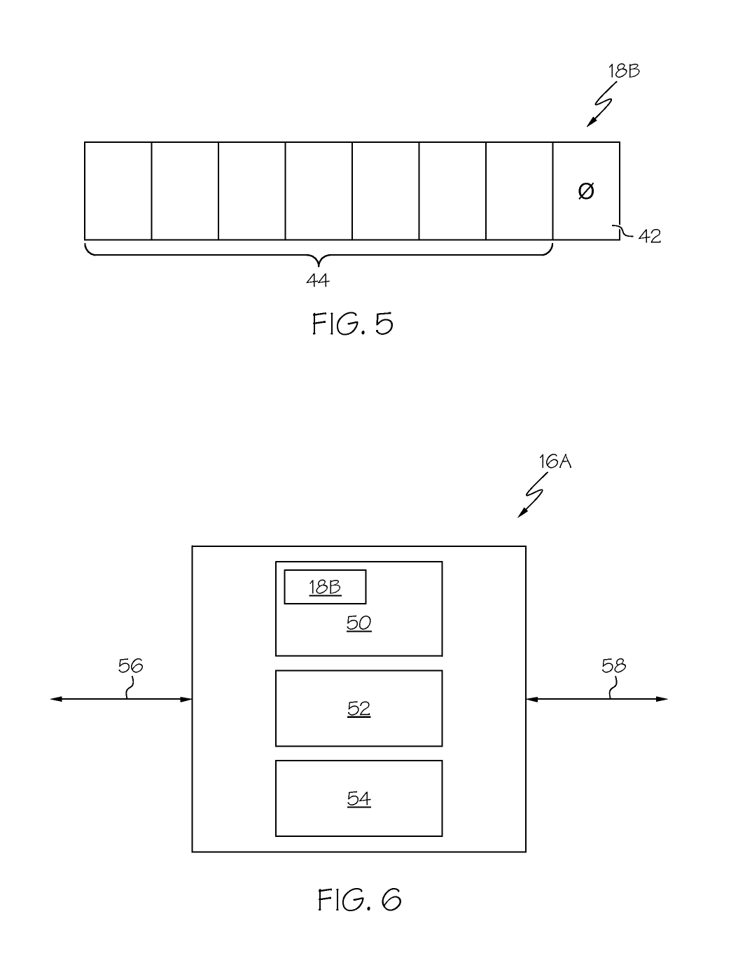

FIG. 5 shows a switch 18B according to another embodiment. The switch 18B may be a register which may reside in the memory of the processing unit. For example, the switch 18B may comprise a single register in the non-volatile EEPROM (electrically erasable programmable read only memory) of the processing unit. Other types of memory may be used as well. As shown in FIG. 5, the switch 18B may comprise a register comprising 8 binary digits (called “bits”). In this embodiment, the right-most bit 42 may indicate the state of the switch 18B. When this bit is set to zero, the switch 18B may be considered as being in the first state. Likewise, when this bit is set to one, the switch 18B may be considered as being in the second state. The remaining bits 44 of the register may either be used to configure other characteristics of the pressure sensor, or they may be left unused. The switch 18B may comprise a 16-bit register, a 32-bit register, or any other register of suitable length.

FIG. 6 depicts a processing unit 16A according to one or more embodiments shown and described herein. The processing unit 16A may comprise EEPROM (electrically-erasable programmable read-only memory) 50, a CPU (central processing unit) 52, and RAM (random access memory) 54, and other such peripherals which facilitate the operation of the processing unit 16A. The CPU 52 may comprise program memory which may store machine readable instructions for the CPU 52 which, when executed, may define the operation of the pressure sensor. The computer program may be written by a programmer in the “C” programming language, assembly language, or any other suitable computer programming language. The computer program may be compiled into machine readable instructions and subsequently stored in the program memory. The RAM 54 may store variables during the execution of the program instructions. For example, the RAM 54 may store one or more past samples of the measured atmospheric pressure and/or relative pressure of the fluid. The EEPROM 50 may store configuration information about the pressure sensor which may define how the pressure sensor operates. The EEPROM 50 may also contain the switch 18A (e.g., an EEPROM register) which determines whether the pressure sensor determines the absolute pressure or the relative pressure of the fluid.

The processing unit 16A may also comprise one or more timers which may facilitate the operation of the processing unit 16A by permitting certain events to occur at relatively precise intervals. As an example, one timer may set the update rate for the atmospheric pressure measurement. The processing unit may further comprise an SPI interface 56 which may allow the processing unit 16A to read data from and write data to other electronic devices, such as the atmospheric pressure sensing element, the fluid pressure sensing element, and/or the interface unit. In one embodiment, the same SPI interface 56 may be used to interface to both the atmospheric pressure sensing element and the fluid pressure sensing element. The processing unit 16A may comprise other peripherals, as is known in the art, in order to facilitate its operation such as, but not limited to, an oscillator, a reset circuit, and general purpose input/output pins 58.

In one embodiment, the processing unit 16A may comprise a PIC24F16KA101 microcontroller from Microchip Technology (Chandler, Ariz.; www.microchip.com). The PIC24F16KA101 comprises all the peripherals shown in FIG. 6, including EEPROM 50, a CPU 52 (including program memory), RAM 54, an SPI interface 56, and general purpose input output pins 58. The PIC24F16KA101 also comprises timers, a reset circuit, an oscillator, two UARTs (universal asynchronous receiver/transmitter), and a 10-bit A-to-D (analog-to-digital) converter. Other types of microcontrollers and microprocessors may be used as well, as is known in the art.

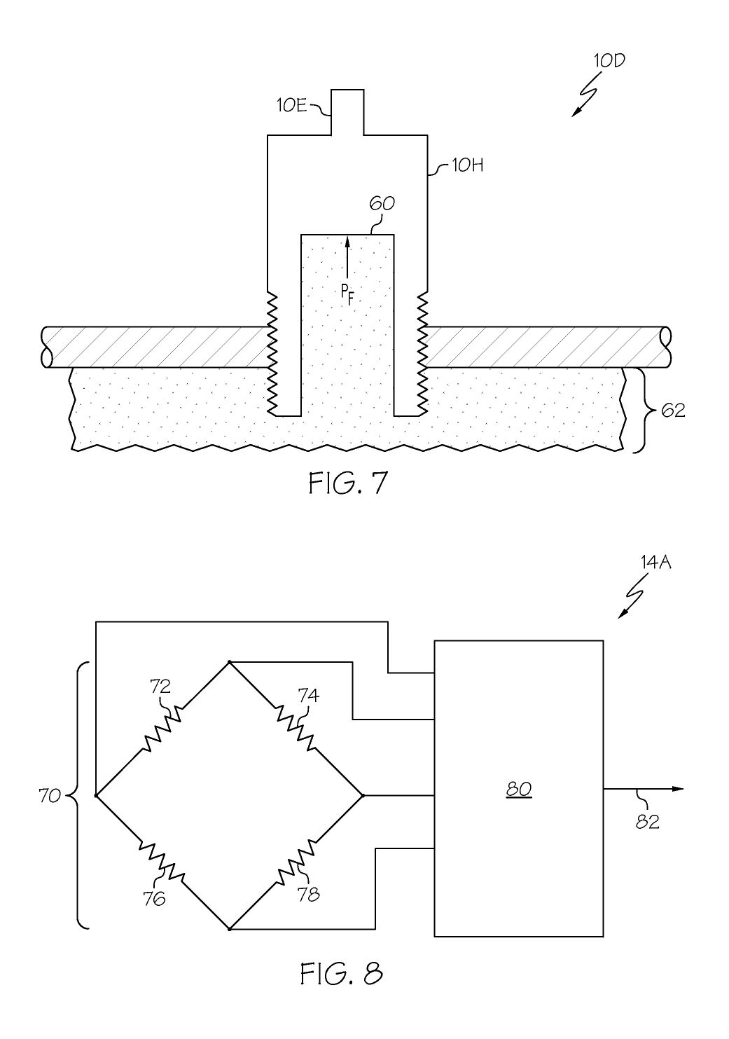

FIG. 7 illustrates a pressure sensor 10D according to one or more embodiments shown and described herein. The pressure sensor 10D may comprise a housing 10H which may house the various components described herein. The housing 10H may be constructed of stainless steel, aluminum, plastic, or any other suitable material. The pressure sensor 10D may be approximately cylindrical in shape and may comprise an electrical connector 10E which may permit electrical access for the input signal and output signal. The pressure sensor 10D may have threads which permit it to be threaded into a vessel containing the fluid 62. For example, the pressure sensor may have ¼-inch NPT (national pipe thread), 7/16-20, or any other suitable thread. The pressure sensor 10D may be installed in a manifold containing the fluid 62 whose pressure is to be measured.

The pressure sensor 10D may comprise a diaphragm 60 which may be mechanically coupled to the fluid 62 whose pressure is being measured. The pressure of the fluid 62 may create a force P_{F} which may act on the diaphragm 60 so as to distort the shape of the diaphragm 60. The amount of pressure of the fluid 62 may distort the diaphragm 60 by a corresponding amount. Resistive pressure sensing elements (not shown) may be affixed to the diaphragm 60 such that the electrical resistance of the resistive pressure sensing element corresponds to the pressure of the fluid 62. The electrical resistance of the resistive pressure sensing elements may be measured by an analog-to-digital converter (not shown). The processing unit may read the analog-to-digital converter so as the measure the relative pressure of the fluid 62.

FIG. 8 shows an electrical schematic of a fluid pressure sensing element 14A according to one embodiment shown and described herein. The fluid pressure sensing element 14A may comprise a full bridge 70. The full bridge 70 may comprise two half bridges which may be electrically connected as a Wheatstone bridge, as shown. Alternatively, the two half bridges may be electrically independent, or they may be electrically connected in any suitable manner. In one embodiment, the full bridge 70 may comprise one or more resistive pressure sensing elements 72, 74, 76, 78 which may be mechanically coupled to the fluid (e.g., via the diaphragm as shown in FIG. 7). The resistance of the resistive pressure sensing elements 72, 74, 76, 78 may change when the relative pressure of the fluid changes.

The fluid pressure sensing element 14A may further comprise an analog-to-digital converter 80. The analog-to-digital converter 80 may be electrically coupled to the one or more resistive pressure sensing elements 72, 74, 76, 78 such that the analog-to-digital converter 80 is operable to measure the relative pressure of the fluid by measuring the resistance of the one or more resistive pressure sensing elements 72, 74, 76, 78. The analog-to-digital converter 80 may comprise any suitable type of converter, including but not limited to delta-sigma converters, successive approximation converters, and time-to-digital converters. In one embodiment, the analog-to-digital converter 80 may comprise a time-to-digital converter, such as one available from Acam, GmbH (Stutensee-Blankenloch, Germany; website: www.acam.de). For example, the analog-to-digital converter 80 may comprise the PS09 time-to-digital converter (called strain gage amplifier by Acam, GmbH). Other suitable types of analog-to-digital converters may be used as well.

The analog-to-digital converter 80 may be electrically coupled to the processing unit such that the processing unit is operable to read the measured relative pressure of the fluid from the analog-to-digital converter 80. The analog-to-digital converter 80 may determine the relative pressure of the fluid by measuring the resistance of the resistive pressure sensing elements 72, 74, 76, 78 of the two or more half bridges and produce a digital result corresponding to said resistance. The digital result may comprise a separate measurement for each individual resistive pressure sensing element, it may comprise a combined measurement of the two resistive pressure sensing elements of each half bridge, or it may combine measurement of all half bridges into a single number. Furthermore, the digital result may comprise a ratio of the resistance values of the two resistive pressure sensing elements of each half bridge. In addition, the digital result may also comprise a status register which may indicate whether the resistance of each resistive pressure sensing element is within a particular range, such as for example, a working range within which valid resistance measurements are expected. If the resistance measurement falls outside this working range, the corresponding resistive pressure sensing element may be considered to have malfunctioned.

While particular embodiments and aspects of the present invention have been illustrated and described herein, various other changes and modifications may be made without departing from the spirit and scope of the invention. Moreover, although various inventive aspects have been described herein, such aspects need not be utilized in combination. It is therefore intended that the appended claims cover all such changes and modifications that are within the scope of this invention.

What is claimed is:

1. A pressure sensor for measuring the pressure of a fluid, the pressure sensor comprising an atmospheric pressure sensing element, a fluid pressure sensing element, a processing unit, a switch, and an interface unit wherein:
the atmospheric pressure sensing element is operable to measure atmospheric pressure and is electrically coupled to the processing unit such that the processing unit is operable to read a measured atmospheric pressure from the atmospheric pressure sensing element;
the fluid pressure sensing element is mechanically coupled to the fluid and is operable to measure relative pressure of the fluid with respect to the atmospheric pressure, and the fluid pressure sensing element is electrically coupled to the processing unit such that the processing unit is operable to read a measured relative pressure of the fluid from the fluid pressure sensing element;
the interface unit is electrically coupled to the processing unit and is operable to receive a digital number from the processing unit and convert the digital number to an output signal;
the switch is electrically coupled to the processing unit and comprises a first state and a second state, wherein:
when the switch is set to the first state, the processing unit determines the absolute pressure of the fluid based on the measured atmospheric pressure and the measured relative pressure of the fluid, and the digital number and the output signal correspond to the absolute pressure of the fluid; and
when the switch is set to the second state, the processing unit determines the relative pressure of the fluid based on the measured relative pressure of the fluid, and the digital number and the output signal correspond to the relative pressure of the fluid.

2. The pressure sensor of claim 1, wherein the switch comprises a mechanical switch operable to be set by a user of the pressure sensor.

3. The pressure sensor of claim 1, wherein the processing unit comprises the switch, and the switch comprises a digital register comprising the first state and the second state.

4. The pressure sensor of claim 1 wherein the processing unit is operable to receive an input signal, such that the input signal is operable to command the processing unit to set the switch to the first state or the second state.

5. The pressure sensor of claim 4 wherein the input signal comprises an asynchronous serial message comprising one or more message bytes.

6. The pressure sensor of claim 1, wherein the interface unit comprises a digital-to-analog converter, and the output signal comprises an analog voltage or an analog current corresponding to the absolute pressure of the fluid or the relative pressure of the fluid.

7. The pressure sensor of claim 1, wherein the interface unit comprises an Ethernet interface, and the output signal comprises one or more Ethernet signals.

8. The pressure sensor of claim 7, wherein the Ethernet interface unit is operable to receive an Ethernet input signal such that the Ethernet input signal is operable to command the processing unit to set the switch to the first state or the second state.

9. The pressure sensor of claim 1, wherein the interface unit comprises a wireless interface, and the output signal comprises one or more wireless signals.

10. The pressure sensor of claim 9, wherein the wireless interface is operable to receive a wireless input signal such that the wireless input signal is operable to command the processing unit to set the switch to the first state or the second state.

11. The pressure sensor of claim 9, wherein the wireless interface is a Wi-Fi interface, a Bluetooth interface, or a cellular interface.

12. The pressure sensor of claim 1, wherein the processing unit comprises a microcontroller.

13. The pressure sensor of claim 1, wherein the fluid pressure sensing element comprises one or more resistive pressure sensing elements and an analog-to-digital converter, wherein:
the one or more resistive pressure sensing elements are mechanically coupled to the fluid and are operable to change resistance when the pressure of the fluid changes; and
the analog-to-digital converter is electrically coupled to the one or more resistive pressure sensing elements such that the analog-to-digital converter is operable to measure the relative pressure of the fluid by measuring the resistance of the one or more resistive pressure sensing elements; and
the analog-to-digital converter is electrically coupled to the processing unit such that the processing unit is operable to read the measured relative pressure of the fluid from the analog-to-digital converter.

14. A method for configuring a pressure sensor for measuring the pressure of a fluid, wherein the pressure sensor comprises an atmospheric pressure sensing element, a fluid pressure sensing element, a processing unit, a switch, and an interface unit wherein:
the atmospheric pressure sensing element is operable to measure atmospheric pressure and is electrically coupled to the processing unit such that the processing unit is operable to read a measured atmospheric pressure from the atmospheric pressure sensing element;
the fluid pressure sensing element is mechanically coupled to the fluid and is operable to measure relative pressure of the fluid with respect to the atmospheric pressure, and the fluid pressure sensing element is electrically coupled to the processing unit such that the processing unit is operable to read a measured relative pressure of the fluid from the fluid pressure sensing element;
the interface unit is electrically coupled to the processing unit and is operable to receive a digital number from the processing unit and convert the digital number to an output signal;
the switch is electrically coupled to the processing unit and comprises a first state and a second state, wherein:
when the switch is set to the first state, the processing unit determines the absolute pressure of the fluid based on the measured atmospheric pressure and the measured relative pressure of the fluid, and the digital number and the output signal correspond to the absolute pressure of the fluid; and
when the switch is set to the second state, the processing unit determines the relative pressure of the fluid based on the measured relative pressure of the fluid, and the digital number and the output signal correspond to the relative pressure of the fluid;
and the method comprises:
setting the switch to the first state such that the pressure sensor measures the absolute pressure of the fluid, or setting the switch to the second state such that the pressure sensor measures the relative pressure of the fluid.

15. The method of claim 14, wherein the switch comprises a mechanical switch, and setting the switch to the first state or the second state comprises adjusting the mechanical switch.

16. The method of claim 14, wherein the processing unit is operable to receive an input signal, such that the input signal is operable to command the processing unit to set the switch to the first state or the second state, and setting the switch to the first or second state comprises sending a message to the processing unit via the input signal.

17. The method of claim 16, wherein the input signal comprises an asynchronous serial message comprising one or more message bytes.

18. The method of claim 14, wherein the interface unit comprises a wireless interface, and the output signal comprises one or more wireless signals.

19. The method of claim 18, wherein the wireless interface is operable to receive a wireless input signal such that the wireless input signal is operable to command the processing unit to set the switch to the first state or the second state, and setting the switch to the first or second state comprises sending a wireless message to the processing unit via wireless interface.

20. The method of claim 18, wherein the wireless interface is a Wi-Fi interface, a Bluetooth interface, or a cellular interface.
